(19) United States
(12) Patent Application Publication
(10) Pub. No.: US 2012/0275608 A1
(43) Pub. Date: Nov. 1, 2012

(54) METHOD FOR ENCODING/DECODING AN IMPROVED STEREO DIGITAL STREAM AND ASSOCIATED ENCODING/DECODING DEVICE

(76) Inventors: Frédéric Amadu, Chelles (FR); Thomas Esnault, Paris (FR)

(21) Appl. No.: 13/518,993

(22) PCT Filed: Dec. 10, 2010
(86) PCT No.: PCT/FR2010/052671

§ 371 Date: Jun. 25, 2012

(30) Foreign Application Priority Data
Dec. 23, 2009 (FR) 09 59547

(51) Int. Cl. H04R 5/00

(52) U.S. Cl. 381/22

(57) ABSTRACT

A method for encoding and decoding a digital audio signal composed of an original right-hand signal (S_{DO}) and an original left-hand signal (S_{GO}). The method combines the original right-hand signal (S_{DO}) and the original left-hand signal (S_{GO}) to obtain a single combined signal (S_{C}), encodes the combined signal (S_{C}) using a standard encoder to obtain a compressed combined signal (S_{CC}), and decodes the compressed combined signal (S_{CC}) using a standard decoder (8) to obtain a decompressed combined signal (S_{CD}). After decoding, the method generates a reconstructed right-hand signal (S_{DR}) and a reconstructed left-hand signal (S_{GR}) from the decompressed combined signal (S_{CD}), which are de-correlated from each other. Also, a treble-generating module enables the high-frequency component (S_{HF}) of the right-hand (S_{DR}) or left-hand (S_{GR}) signals to be recreated, which signals had been deleted as a result of the compression.

### TECHNICAL FILED OF THE INVENTION

The invention relates to a method for encoding/decoding a digital stereo sound stream as well as a device made up of an encoder and an associated decoder. The purpose of the invention is in particular to improve a standard system of the type encoder/decoder (codec) making it possible to encode and decode a digital stereo/audio stream.

The invention finds an application particularly advantageous in the field of codecs for the compression of stereo/audio signals such as for example codecs of the type MP3. However, the invention could also be used with any type of codec adapted to the encoding and the decoding of two digital sound signals.

### BACKGROUND OF THE INVENTION

Digital codecs of the type MP3 or other formed by a standard encoder makes it possible to encode, according to a known encoding protocol, digital stereo sound signals for example in WAVE format in order to transform said digital stereo sound signals into encoded stereo signals; a standard decoder is also known which makes it possible to decode, according to a known decoding protocol, encoded stereo signals in order to transform them into digital stereo signals for example in WAVE format. In general, encoding consists in compressing stereo signals, while decoding consists in decompressing compressed stereo signals.

The problem is that the transmission channel available for encoding is generally limited to N kbits/s (N generally being equal to 64 or 128). However when a stereo signal formed of two audio channels: a right sound channel and a left sound channel, is encoded according to the characteristics of the codecs used, it can be necessary to encode approximately each audio channel of the signal at a transfer rate of N/2 kbits/s.

### OBJECT AND SUMMARY OF THE INVENTION

The invention makes it possible to increase the quality of the final stereo signal without increasing the transfer rate in the transmission channel; or to preserve the quality of the final stereo signal by reducing the transfer rate in the transmission channel.

For this purpose, the device according to the invention comprises a so-called pre-processing module associated with the standard encoder acting before the encoding process, which combines the stereo signals in order to transform said stereo signals into a single combined signal. The invention also comprises a post-processing module associated with the decoder acting after decoding the compressed signal, which makes it possible to generate the two audio signals from the single combined signal generated by the pre-processing module. The function of this post-processing module is to generate two sound signals (right and left) decorrelated relative to one another from the decompressed combined signal.

Thus, in the invention, there is only one signal to be encoded (the single combined signal) instead of the two right and left signals in the traditional methods. That makes it possible either to less compress the combined signal in order to increase the quality of the final signal, or to decrease the transfer rate in the transmission channel while having the same quality as with the existing encoding methods.

Preferably, in order to enable the decoder to detect whether it is question of a stream encoded by the method according to the invention or a standard stream not encoded by the invention, a meta-datum is added into the data frame encoded by the encoder, which indicates whether the method according to the invention is activated or not. The site of this meta-datum in the frame encoded by the encoder can vary according to the standard encoding used.

The invention thus relates to a method for encoding and decoding a digital audio signal composed of an original right sound signal and of an original left sound signal, wherein said method comprises the following steps:
before encoding, the original right sound signal and the original left sound signal are combined in order to obtain a single combined signal,
the combined signal is encoded by means of a standard encoder in order to obtain a compressed combined signal,
the compressed combined signal is decoded by means of a standard decoder in order to obtain a decompressed combined signal, and
after decoding, a restored right sound signal and a restored left sound signal decorrelated relative to one another corresponding respectively to the original right sound signal and the original left sound signal are generated from the decompressed combined signal.

According to an implementation, in order to combine the right and left original sound signals into a single combined signal, a point-to-point weighted sum of the samples of the original right sound signal and the original left sound signal are carried out in the temporal field.

According to an embodiment, in order to generate from the decompressed combined signal the restored right and left sound signals, the decompressed combined signal is applied to the input of a first and a second elementary block, the output signal for these blocks corresponding respectively to the restored right electric sound signal and to the restored left electric sound signal, the output signal for each block being the combination of the input signal for the block weighted by a first gain, and of the combination of the output signal for the block weighted by a second gain and of the input signals for the block delayed by a delay line.

According to an embodiment:

for the first elementary block,

s₁(n)=e₁(n).g₁+s₁(n−D1).g₂+e₁(n−D1)

e₁ being the input signal for the first block corresponding to the decompressed combined signal,

s₁ being the output signal for the first block corresponding to one of the restored sound signals (right or left),

g₁, g₂ being respectively the values of the first gain and the second gain for the first block,

n being the n^{th} harmonic sample,

D1 being the value of the number of delay samples introduced by the delay line, and

for the second elementary block:

s₂(n)=e₂(n).g₃+s₂(n−D2).g₄+e₂(n−D2)

e₂ being the input signal for the second block corresponding to the decompressed combined signal,

s₂ being the output signal for the second block corresponding to the other restored sound signal (right if s₁ corresponds to the left one or left if s₁ corresponds to the right one),

g₃, g₄ being respectively the values of the first gain and the second gain for the second block,

n being the n^{th} harmonic sample,

D2 being the value of the number of delay samples introduced by the delay line.

According to an embodiment, the gain values inside a block are opposite one another, the value of the first gain being opposite the value of the second gain.

According to an embodiment, the gain values of the first block are opposite the gain values of the second block, the value of the first gain of the first block being opposite the value of the first gain of the second block; while the value of the second gain of the first block is opposite the value of the second gain of the second block.

According to an embodiment, the gain values of the first and second elementary block have the same absolute value.

According to an embodiment, the first gain of the first block and the second gain of the second block are equal to g; while the second gain of the first block and the first gain of the second block are equal to −g.

According to an embodiment, the delay introduced by the line of the first block and the delay introduced by the line of the second block is equal to one another.

According to an embodiment, the decompressed combined signal is first filtered by means of a high-pass filter and only the filtered high frequency part is applied to the input of the elementary blocks.

According to an embodiment,
the low frequency part of the decompressed combined signal is filtered,
the thus-filtered low frequency part is delayed with a third delay by means of a third delay line, and
the thus-delayed low frequency part is added to the output signals of the elementary blocks obtained from the high frequency part in order to obtain the restored right sound signal and the restored left sound signal.

According to an embodiment, the output signals of each elementary block by means of parametric filtering cells is filtered in gain and in phase in order to modify the sound perception of these output signals.

According to an embodiment, to enable the decoder to detect whether it is question of an encoded stream formed of a combined signal or a standard stream, a meta-datum is added into the data frame encoded by the encoder, which indicates whether the step of combining the original right and left signals into a single combined signal is activated or not.

According to an embodiment, for each restored right and left sound signal primarily formed of a low frequency component lower than a cut-off frequency,
the highest frequency part of the restored sound signal is isolated by means of a first filter of the band-pass type,
the isolated part is duplicated with regard to the frequency by means of a nonlinear processor which generates the high frequency harmonics of the isolated signal in order to obtain a duplicated signal,
a second band-pass filter is applied to the duplicated signal in order to obtain a high frequency component,
the thus-generated high frequency component is combined with the restored sound signal beforehand delayed by a delay cell, and
an increased restored signal comprising a low frequency component and a regenerated high frequency component is obtained,
upper and lower limits of the band-pass filter depending on the compression ratio applied by the method.

The invention moreover relates to a digital stream encoder used with the decoder according to the invention for the implementation of the method for encoding and decoding a digital audio signal composed of an original right sound signal and of an original left sound signal according to the invention, wherein said digital stream encoder comprises:
a pre-processing means able to combine, before encoding, the original right sound signal and the original left sound signal in order to obtain a single combined signal, and
a standard encoder able to encode the combined signal in order to obtain a compressed combined digital signal.

The invention also relates to a digital stream decoder by means of the encoder according to the invention for the implementation of the method for encoding and decoding a digital audio signal composed of an original right sound signal and of an original left sound signal according to the invention, wherein said digital stream decoder comprises:
a standard decoder able to decode a single compressed combined signal in order to obtain a decompressed combined signal, and
a post-processing module able to generate, after decoding, from the decompressed combined signal, a restored right sound signal and a restored left sound signal decorrelated relative to one another corresponding respectively to the original right sound signal and the original left sound signal.

According to an embodiment, said decoder moreover comprises a module for generating treble frequencies including:
a first filter of the band-pass type for isolating the highest frequency part of the restored sound signal,
a nonlinear processor which generates the high frequency harmonics of the isolated signal in order to duplicate the isolated part with regard to the frequency so as to obtain a duplicated signal,
a second band-pass filter applied to the duplicated signal so as to obtain a high frequency component,
means for combining the thus-generated high frequency component with the restored sound signal beforehand delayed by a delay cell, so as to obtain an increased restored signal comprising a low frequency component and a regenerated high frequency component.

According to an embodiment, the upper and lower limits of the band-pass filter depend on the compression ratio applied by the method.

### BRIEF DESCRIPTION OF THE DRAWINGS

The invention will be better understood when reading the following description and examining the annexed figures. These figures are given only as an illustration but by no means a restriction of the invention. They show:

FIG. 1: a schematic representation of an encoding/decoding device according to the invention;

FIG. 2: a graphical representation of the original stereo signals and the signal resulting from a nonrestrictive particular combination of these signals by the pre-processing module;

FIG. 3: a schematic representation of the blocks forming the post-processing module according to the invention;

FIG. 4: a schematic representation of the blocks forming the post-processing module in an improvement of the invention;

FIG. 5: a schematic representation of a frame encoded by a standard encoder showing a meta-datum introduced by the method according to the invention;

FIG. 6: a schematic representation of a module for generating high frequency components for the decoded stereo signals to be broadcast;

FIGS. 7a-7e: very schematic representations of the signals that can be observed when using the module for generating high frequency components in FIG. 6.

### DETAILED DESCRIPTION OF THE EMBODIMENTS

Identical elements have the same reference throughout the figures.

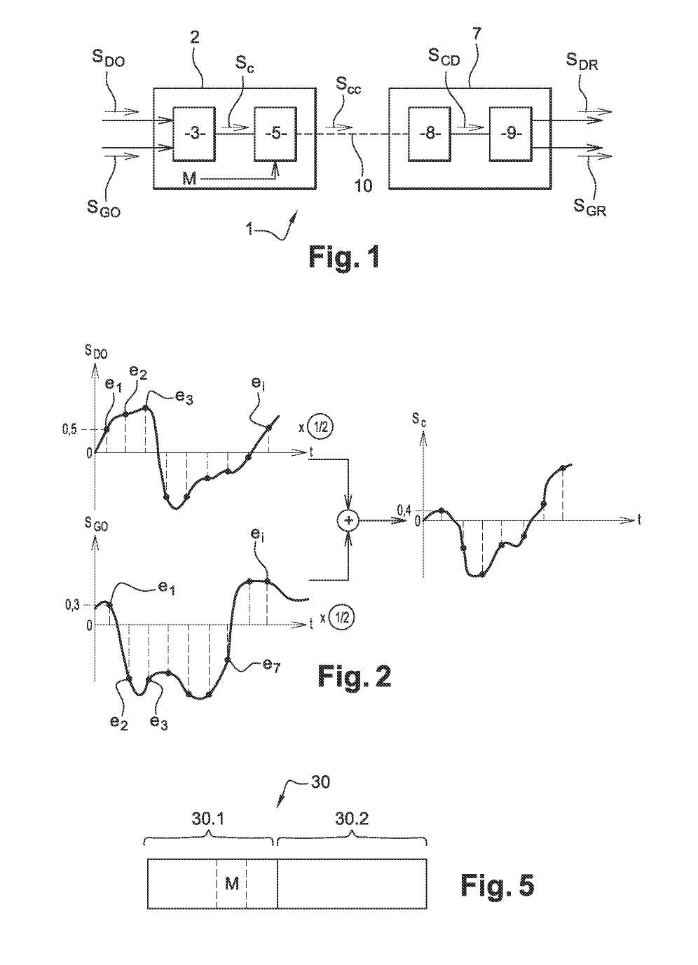

FIG. 1 shows an encoding/decoding device 1 according to the invention comprising an encoder 2 according to the invention formed by a pre-processing module 3 associated with a standard encoder 5. The encoder 5 can be for example a digital audio encoder of the mp3 type such as for example the encoder LAME or an encoder for encoding sound streams for digital television.

In addition, the device 1 according to the invention comprises a decoder 7 according to the invention formed by a standard decoder 8 and an associated post-processing module 9. The decoder 8 could be for example a decoder of the MP3 type integrated into a digital music player or an audio decoder integrated into a digital television decoder (set top box).

When operating, a stereo signal formed by an original right sound signal S_{DO} and an original left sound signal S_{GO} are applied to the input of the pre-processing module 3. The original right S_{DO} and left S_{GO} sound signals are sampled and quantified signals. As shown in FIG. 2, the module 3 carries out the combination of the signal S_{DO} and the signal S_{GO}, so as to output a single combined signal S_{c}. In an example, the signals S_{DO} and S_{GO} are weighted with a coefficient of 0.5 and are then sample-to-sample added for generating S_{c}.

The combined signal S_{c} is applied to the input of the encoder 5 which compresses the signal S_{c} according to a known compression protocol so as to obtain a compressed combined signal S_{CC}. This signal S_{CC} could be for example transmitted on any type of wired media, radio, or other or even saved on a digital storage medium such as for example a CD-ROM or a memory of the USB type.

Since it is enough to encode the combined signal S_{C} whereas the two signals (right and left) of the stereo signal need to be encoded in the existing methods, it is clear that the method according to the invention makes it possible to limit the stream in the available encoding channel 10, or then to reduce the compression ratio for improving the final sound rendering if the same transfer rate as in the existing methods is kept.

The compressed combined signal S_{CC} is applied to the input of the decoder 8 which decompresses it, according to a known decompression protocol, so as to obtain a decompressed combined signal S_{CD}.

The signal S_{CD} is then applied to the input of the post-processing module 9 comprising, as shown in FIG. 3, a decorrelating module 11 for the signal which makes it possible to generate, from the signal S_{CD}, two signals decorrelated relative to one another: the restored right sound signal S_{DR} and the restored left sound signal S_{GR} corresponding to the original right and left sound signal S_{DO} and S_{GO}.

For this purpose, the decorrelating module 11 is made of two elementary blocks 13.1-13.2 to the input of which the decompressed combined signal S_{CD} is applied, the output of these blocks 13.1, 13.2 corresponding respectively to the restored right sound signal S_{DR} and to the restored left sound signal S_{GR}. The output signal s₁ (resp. s₂) of each block 13.1 (resp. 13.2) depends on the combination of the input signal e₁ (resp. e₂) for the block weighted with a first gain g₁ (resp. g₃), and of the combination of the input signals e₁ (resp. e₂) and of the output signal s₁ (resp. s₂) for the block weighted with a second gain g₂ (resp. g₄), delayed by a delay line 14.1 (resp .14.2).

According to an embodiment, for each elementary block 13.1, 13.2, the input signal e₁, e₂ is applied to the input of a first adder 16.1, 16.2 and is applied to an input of a second adder 17.1, 17.2 after being multiplied by the first gain g₁, g₃. The output signal s₁, s₂ for the block is applied to another input of the first adder 16.1, 16.2 after being multiplied by the second gain g₂, g₄, the output signal of the first adder 16.1, 16.2 being applied to the input of the delay line 14.1, 14.2. The output signal for the delay line 14.1, 14.2 is applied to another input of the second adder 17.1, 17.2, the output signal for this second adder 17.1, 17.2 corresponding to the output signal s₁, s₂ of for block and thus to the restored right S_{DR} or left S_{GR} sound signal.

Thus, for the first elementary block 13.1:

s₁(n)=e₁(n).g₁+s₁(n−D1).g₂+e₁(n−D1)

e₁ being the input signal for the first block 13.1 corresponding to the decompressed combined signal,

s₁ being the output signal for the first block 13.1 corresponding to one of the restored sound signals (right or left),

g₁, g₂ being respectively the values of the first gain and the second gain of the first block 13.1,

n being the n^{th} harmonic sample,

D1 being the value of the number of delay samples introduced by the delay line 14.1.

For the second elementary block 13.2:

s₂(n)=e₂(n).g₃+s₂(n−D2).g₄+e₂(n−D2)

e₂ being the input signal for the second block 13.2 corresponding to the decompressed combined signal,

s₂ being the output signal for the second block 13.2 corresponding to the other restored sound signal (right if s₁ corresponds to the left one or left if s₁ corresponds to the right one),

g₃, g₄ being respectively the values of the first gain and the second gain of the second block 13.2,

n being the n^{th} harmonic sample,

D2 being the value of the number of delay samples introduced by the delay line 14.2.

Preferably, inside the same block 13.1 (resp. 13.2), the first gain g₁ (resp. g₃) and the second gain g₂ (resp. g₄) have values opposite one another. Each block 13.1, 13.2 then behaves as a filter of the all-pass type which does not modify the gain of the input signal e₁, e₂ but only the phase thereof.

Moreover, the gains g₁, g₂ of the first block 13.1 and the gains g₃, g₄ of the second block 13.2 have preferably values opposite one another. Thus, the value of the first gain g₁ of the first block 13.1 is opposite the value of the first gain g₃ of the second block 13.2; while the value of the second gain g₂ of the first block 13.1 is opposite the value of the second gain g₄ of the second block 13.2.

Gains for the first 13.1 and the second 13.2 block which have an identical absolute value g will also preferably be chosen. Thus, preferably, the first gain g₁ of the first block 13.1 and the second gain g₄ of the second block 13.2 have a value g; while the second gain g₂ of the first block 13.1 and the first gain g₃ of the second block 13.2 have a value −g.

Preferably, the delays D1, D2 introduced by the delay line 14.1 of the first elementary block 13.1 and the delay line 14.2 of the second elementary block 13.2 are equal to one another. However, it would be possible to choose delays D1, D2 with different durations

In an embodiment example, g=0.4 and delays D1 and D2 of 176 samples each are chosen, such values allowing to obtain a good sound rendering.

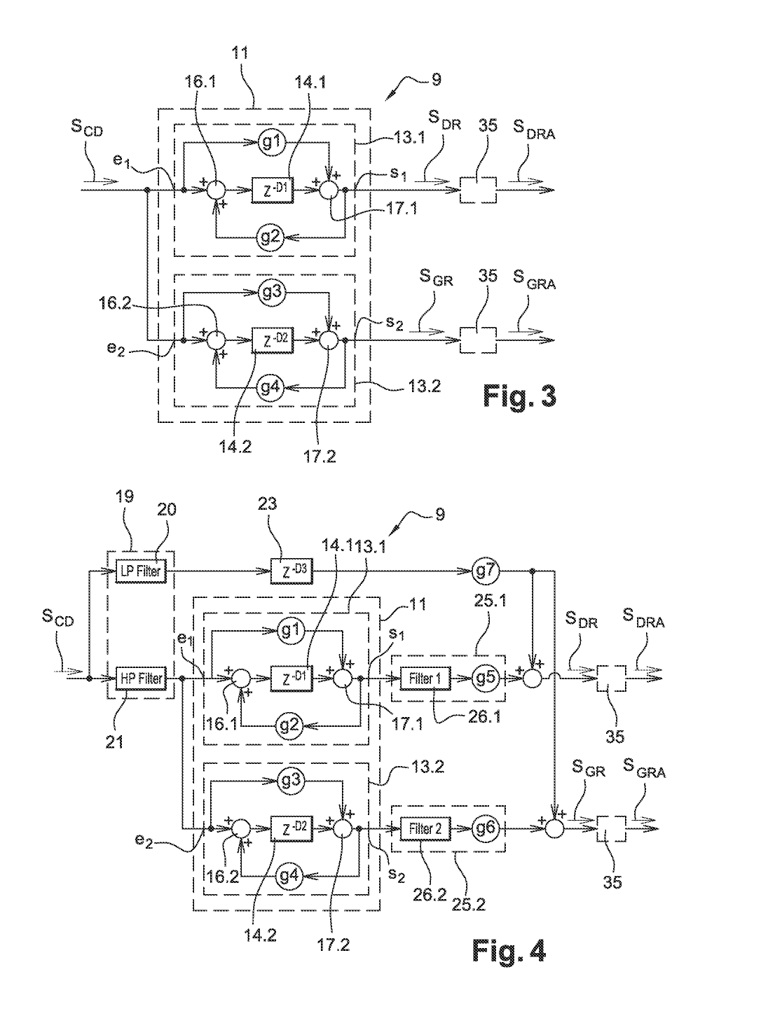

In an improvement of the invention represented in FIG. 4, a stage 19 made up of two low-pass 20 and high-pass 21 filters allowing to separate the low frequency part from the high frequency part of the decompressed combined signal S_{CD} is used. In this case, only the high frequency part of the signal S_{CD} is applied to the input of the decorrelating module 11. In an example, the cut-off frequencies of the low-pass filter 20 and high-pass filter 21 are about 350 Hz.

The low frequency part of the signal S_{CD} is applied to the input of a third delay line 23 and the thus-delayed low frequency part is added, if need be after weighting with a gain g7, to the output signals s₁, s₂ of the elementary blocks, so as to obtain restored right S_{DR} and left S_{GR} sound signals with an improved sound rendering. For one realizes that statistically the low frequency signals are very correlated, it is not therefore advisable to decorrelate them by means of the decorrelating module 11, otherwise the general audiophonic perception will not appear natural in the ear. In an example, the delay D3 applied by the third delay line 23 is equal to 176 samples (at a sampling rate of 44.1 KHz).

Moreover, parametric equalization cells 25.1, 25.2 is connected to the output of each elementary block 13.1, 13.2 before addition to the delayed low frequency part. These cells 25.1, 25.2 cause the modification of the perception of the output signals s₁, s₂ of these blocks 13.1, 13.2 because, even if the signals s₁, s₂ have substantially identical levels, there are differences in the perception thereof because of the decorrelation relative to one another. Consequently, it can be useful to modify these signals from a perceptive point of view so that the general sound impression is as best as possible.

For this purpose, each equalization cell 25.1, 25.2 comprises a filter 26.1, 26.2 whose gain and phase can be adjusted according to various frequency bands of the signals s₁, s₂ and a gain g5, g6 which act on all the spectrum of the signals s₁, s₂. These gain and phase parameters are adapted by sound engineers in particular according to the application considered.

Preferably, in order that the decoder 8 can detect whether it is question of a stream encoded by the method according to the invention or of a standard stream not encoded by the invention, a meta-datum M is added into the data frame encoded by the encoder 5, which indicates whether the method according to the invention is activated or not. This meta-datum M is of the static type, i.e. it will be able for example to take only two different values so that, when the decoder 7 detects in the encoded frame the first value (for example 1) corresponding to the activation of the pre-processing module 3, it activates the post-processing module 9; and when the decoder 7 detects in the encoded frame the second value corresponding to the deactivation of the pre-processing module 3, it inhibits the post-processing module 9 and uses in a traditional way the standard decoder 8 for decoding the stereo signal in the two right and left channels. Indeed, in the case of the deactivation of the module 3, the signals S_{DO} and S_{GO} are directly applied to the input of the standard encoder 5 for a traditional encoding, then transmitted to the decoder 8, then decoded in a traditional way by the decoder 8 in order to obtain a restored left signal S_{GR} and a restored right signal S_{DR}.

The site of this meta-datum M in the frame 30 encoded by the encoder 5 can vary according to the standard encoding used. FIG. 5 shows a schematic representation of an encoded frame 30 comprising a heading 30.1 in particular indicating the type of encoding used and the length of the frame 30 as well as a data part 30.2 in which the encoded data are packed. The meta-datum M will be introduced into a site of the heading 30.1 left available by the standard encoding protocol.

In an improvement of the invention, an analysis of the correlation between the original right S_{DO} and left S_{GO} sound signals are carried out in definite frequency bands so as to produce a coefficient representative of the correlation in each band.

The calculated correlation coefficients are packed as meta-data into the heading 30.1 of the encoded signal.

Then, the parameters g₁, g₂, g₃, g₄, D1, D2 of the elementary blocks 13.1 and 13.2 are adapted according to the received correlation values, so as to decorrelate each range of frequencies differently.

For this purpose, a table stored in a memory gives the correspondence between the parameters of each block 13.1, 13.2 (first gain g₁, g₃ and second gain g₂, g₄ and delay D1, D2 of the line 14.1, 14.2) and the received correlation ratios. The decorrelation ratio of the decorrelating module 11 is then modified by selecting in the table the parameters (g₁-g₄, D1, D2) corresponding to the correlation coefficient received.

In addition, it is known that the upper cut-off frequency f_{C} of the restored signals depends on the compression ratio T applied by the encoder 5. Indeed, for compression ratios T corresponding to a transfer rate of 128 kbits/s there is a cut at 15 kHz for signals in MP3 encoders; while for compression ratios T corresponding to a transfer rate of 64 kbits/S, there is a cut at 10 kHz for signals. In other words, the higher the compression ratio T is, the more the high frequency component of the signals is reduced.

The invention makes it possible to regenerate the high frequency component of the right S_{DR} or left S_{GR} sound signals which has been suppressed because of the compression. This aspect of the invention is independent of the principle of generation of the two stereo-decompressed sound signals S_{DR} and S_{GR} from only one compressed signal S_{C}.

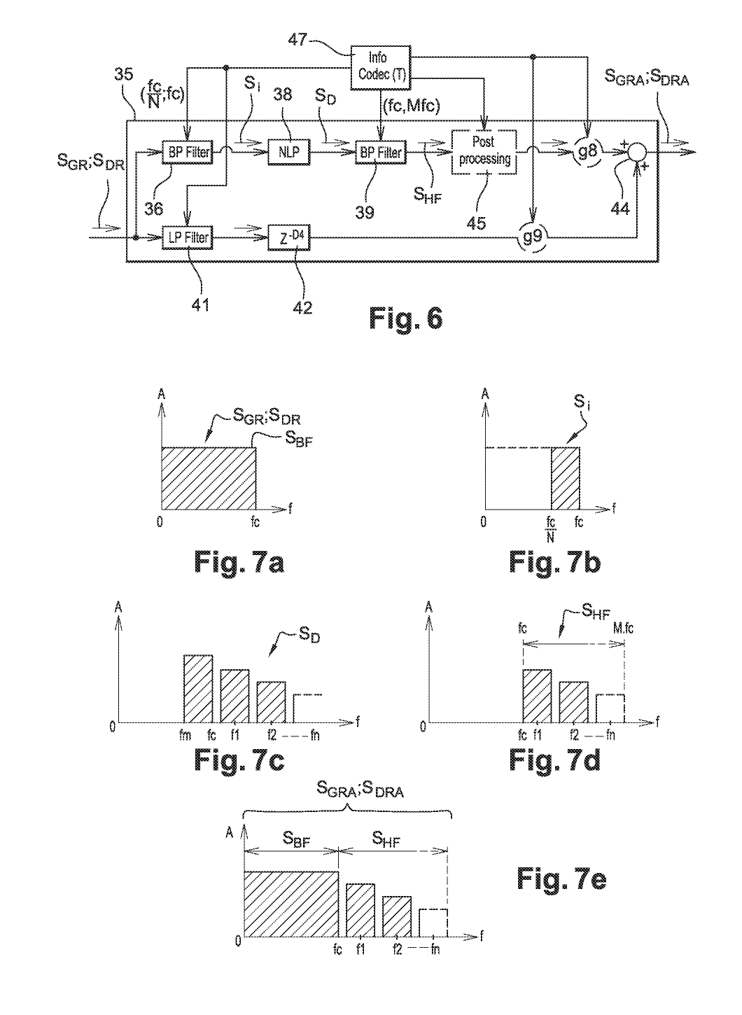

For this purpose, the restored left S_{GR} and right S_{DR} sound signals, which are substantially formed of a low frequency component S_{BF} lower than the cut-off frequency f_{C} (see FIG. 7a), are each applied to the input of a module 35 for generating treble frequencies shown in details in FIG. 6.

This module 35 comprises a first band-pass filter 36 at the input of which the restored left S_{GR} (resp. right S_{DR}) sound signal is applied. This first filters 36 makes it possible to isolate the highest frequency part of the input signal S_{GR} (resp S_{DR}) ranging between a lower limit and an upper limit. In an example, the upper limit is equal to the cut-off frequency f_{C}, and the lower limit is equal to f_{C}/N, N preferably being equal to 2 or 4. The isolated part Si of the restored signal obtained at the output of the band-pass filter 36 is shown in FIG. 7b.

The isolated part Si is then applied to the input of the processor 38 of a nonlinear type which makes it possible to duplicate the isolated signal Si with regard to the frequency by generating the high frequencies harmonics at f₁, f₂, . . . fn of this signal Si, which makes it possible to fill the frequency spectrum in the zone of high frequencies. The duplicated signal S_{D} thus obtained at the output of the nonlinear processor 38 is shown in FIG. 7c. Preferably, as represented, the harmonics of the signal S_{D} have an amplitude which decreases as the frequency increases.

Then the high frequency part of the duplicated signal S_{D} is isolated (without the isolated part Si from which it has been obtained) in order to obtain a high frequency component S_{HF} of the sound signal shown in FIG. 7d. For this purpose, a band-pass filter 39 having a lower limit and an upper limit is used. In an example, the lower limit is equal to f_{C} while the upper limit is equal to 20 kHz.

In addition, the restored left S_{GR} (resp. right S_{DR}) sound signal is filtered by means of a low-pass filter 41 with a cut-off frequency substantially equal to f_{C} to keep only the low frequency component S_{BF} of the restored signal S_{GR}, S_{DR}. The low frequency part S_{BF} is then delayed with a delay D4 by means of a delay cell 42. This delay D4 is about some samples.

Then, the low frequency component S_{BF} is added to the high frequency component S_{HF} by means of an adder 44, in order to obtain an increased restored left S_{GRA} (resp. right S_{DRA}) sound signal formed of the initial low frequency component S_{BF} of the restored sound signal and the high frequency component S_{HF} thus generated by the method according to the invention.

Preferably, but that is not obligatory, a post-processing cell 45 modifies the form of the spectral response of the high frequency component S_{HF}, and gains g8 and g9 are applied to the high frequency S_{HF} and low frequency S_{BF} components before addition by means of the adder 44.

The parameters of the filters 36, 39, 41 depend on the compression ratio T. Indeed, the filters 36, 39, 41 have limits which depend on the cut-off frequency f_{C}. As this cut-off frequency f_{C} depends on the compression ratio T, the limits also depend on the compression ratio T. There is thus a table 47 giving the correspondence between the compression ratio T and the associated filter parameters making it possible to generate the high frequency component of the left and right sound signals.

The parameters of the post-processing cell 45, of the nonlinear processor 38, the delay cell 42, and the gains g8 and g9 also depend on the compression ratio T.

The parameters of the modules for generating treble frequencies 35 which process the left sound signal S_{GR} and the right sound signal S_{DR} are preferably symmetrical, i.e. the module 35 which processes the left sound signal S_{GR} has parameters with the same value as the module 35 which processes the right sound signal S_{DR}.

1-15. (canceled)

16. A method for encoding and decoding a digital audio signal composed of an original right sound signal and of an original left sound signal, comprising the steps of:
combining the original right sound signal and the original left sound signal, before encoding, by a pre-processing module to obtain a single combined signal;
encoding the combined signal using an encoder to obtain a compressed combined signal;
decoding the compressed combined signal by a decoder to obtain a decompressed combined signal;
generating a restored right sound signal and a restored left signal from the decompressed combined signal after decoding, the restored right sound signal and the restored left sound signal de-correlated relative to one another corresponding respectively to the original right sound signal and to the original left sound signal;
adding a static meta-datum into a data frame encoded by the encoder, the static meta-datum indicating whether the pre-processing is activated or not, the static meta-datum having only two different values;
activating a post-processing module by the decoder when the decoder detects in an encoded frame a first value corresponding to activation of the pre-processing module; and
inhibiting the post-processing module and decoding a stereo signal in right and left channels by the decoder when the decoder detects in the encoded frame a second value corresponding to the deactivation of the pre-processing module.

17. The method of 16, wherein the step of generating the restored right and left sound signals from the decompressed combined signal comprises the step of applying the decompressed combined signal to an input of a first and a second elementary block, output signals of the first and second elementary blocks corresponding respectively to the restored right sound signal and to the restored left sound signal; and wherein the output signal of each block is a combination of an input signal of said each block weighted with a first gain, of the output signal of said each block weighted with a second gain, and of the input signals of said each block delayed by a delay line.

18. The method of claim 17, wherein the output signal (s₁) for the first elementary block corresponding to one of the right or left restored sound signal is defined by s₁(n)=e₁(n).g₁+s₁(n−D1).g₂+e₁(n−D1), where e₁ being the input signal for the first elementary block corresponding to the decompressed combined signal, g₁ and g₂ being respectively the values of the first gain and the second gain of the first elementary block, n being n^{th} harmonic sample, and D1 being the value of number of delay samples introduced by the delay line; and
wherein the output signal (s₂) for the second elementary block corresponding to the other restored sound signal is defined by s₂(n)=e₂(n).g₃+s₂ (n−D2).g₄+e₂(n−D2), where e₂ being the input signal for the second elementary block corresponding to the decompressed combined signal, g3 and g4 being respectively the values of the first gain and the second gain of the second block, n being n^{th} harmonic sample, and D2 being the value of number of delay samples introduced by the delay line.

19. The method of claim 17, wherein the gain values inside an elementary block are opposite one another, the value of the first gain being opposite the value of the second gain.

20. The method of claim 17, wherein the gain values of the first elementary block are opposite the gain values of the second elementary block, the value of the first gain of the first elementary block being opposite the value of the first gain of the second elementary block and the value of the second gain of the first elementary block being opposite the value of the second gain of the second elementary block.

21. The method of claim 17, wherein the gain values of the first and second elementary blocks have the same absolute value.

22. The method of claim 17, wherein the first gain of the first elementary block and the second gain of the second elementary block are equal to g; and wherein the second gain of the first elementary block and the first gain of the second elementary block are equal to −g.

23. The method of claim 17, wherein the delay introduced by the delay line of the first elementary block and the delay introduced by the delay line of the second elementary block are equal to one another.

24. The method of claim 17, further comprising the steps of filtering the decompressed combined signal with a high-pass filter, and applying only filtered high frequency part to the input of the elementary blocks.

25. The method of claim 24, further comprising the steps of:
filtering a low frequency part of the decompressed combined signal;
delaying the filtered low frequency part by a third delay line; and
adding the delayed low frequency part to output signals of the elementary blocks obtained from the high frequency part to obtain the restored right sound signal and the restored left sound signal.

26. The method of claim 17, further comprising the step of filtering gain and phase of the output signals of each elementary block by parametric filtering cells to modify sound perception of the output signals.

27. The method of claim 16, further comprising, for each restored right and left sound signal substantially formed of a low frequency component lower than a cut-off frequency, the steps of:
isolating a highest frequency part of the restored sound signal by a first bad-pass filter;
duplicating an isolated part with regard to frequency and generating high frequency harmonics of an isolated signal by a nonlinear processor to obtain a duplicated signal;
applying a second band-pass filter to the duplicated signal to obtain a high frequency component;
combining the high frequency component generated with the restored sound signal delayed by a delay cell to obtain an increased restored signal comprising a low frequency component and a regenerated high frequency component; and
wherein upper and lower limits of the band-pass filters depend on a compression ratio.

28. A digital stream encoder for implementing the method of claim 16 for encoding and decoding the digital audio signal composed of the original right sound signal and of the original left sound signal, comprises a pre-processor for combining, before encoding, the original right sound signal and the original left sound signal to obtain a single combined signal; and an encoder for encoding the combined signal to obtain a compressed combined digital signal.

29. A digital stream decoder for implementing the method of claim 16 for encoding and decoding the digital audio signal composed of the original right sound signal and of the original left sound signal, comprises a decoder for decoding a single compressed combined signal to obtain a decompressed combined signal; and a post-processor for generating, after decoding, from the decompressed combined signal, a restored right sound signal and a restored left sound signal de-correlated relative to one another corresponding respectively to the original right sound signal and to the original left sound signal.

30. The decoder of claim 29, further comprises a module for generating treble frequencies, the module comprises:
a first band-pass filter to isolate a highest frequency part of the restored sound signal;
a nonlinear processor to generate high frequency harmonics of an isolated signal to duplicate the isolated part with regard to the frequency to obtain a duplicated signal;
a second band-pass filter applied to the duplicated signal to obtain a high frequency component; and
a combiner to combine the high frequency component with the restored sound signal delayed by a delay cell to obtain an increased restored signal comprising a low frequency component and a regenerated high frequency component.
